(19) United States
(12) Patent Application Publication
(10) Pub. No.: US 2002/0148890 A1
(43) Pub. Date: Oct. 17, 2002

(54) Counting device for golf games or the like

(76) Inventor: Chen Te Chang, Taichung Hsien (TW)

Correspondence Address: CHARLES E. BAXLEY, 59 John Street-5th Floor, New York, NY, 10038, US

(21) Appl. No.: 09/832,371

(22) Filed: Apr. 12, 2001

(51) Int. Cl. G07G 1/00

(52) U.S. Cl. 235/2

(57) ABSTRACT

A counting device includes one or more spring-biasing member disposed in a housing and having an opening formed in one side for forming a spring arm which has two ends coupled to the spring-biasing member for forming an integral spring-biasing structure. One or more dials are rotatably received in the housing and has an outer peripheral portion engaged with the spring arm and for positioning the dial to the housing. The dial includes a number of projections extended from the outer peripheral portion, the spring arm includes a depression for receiving the projections of the dial.

### BACKGROUND OF THE INVENTION

1. Field of the Invention

The present invention relates to a counting device, and more particularly to a counting device for golf games or the table tennis games or the tennis games or the like.

2. Description of the Prior Art

Typical counting devices may be used for counting the strikes or the score of the golf games or the table tennis games or the tennis games or the like.

Taiwanese Patent Publication No. 81768, published Oct. 16, 1986 discloses one of the typical counting devices which is shown in FIG. 1 and which includes eighteen dials 70 rotatably secured in a housing 71 and partially extended outward of the side portions of the housing 71 for indicating or for counting the score or the strikes of the golf games or the table tennis games or the tennis games or the like. Nine springs 1 are disposed between the pairs of dials 70 and each includes a base portion 2 solidly secured in the housing 71 and each includes a latch 4 bent relative to the springs 1 at a bent end or a bent portion 3 for engaging with the dials 70. The dials 70 may be rotated in one direction only. For example, when counting three (3), but when the user rotates to four (4) instead, the user have to rotate the dial one round through five (5), six (6) . . . to three (3).

Taiwanese Patent Publication No. 145691, published Nov. 11, 1990, and Taiwanese Patent Publication No. 245978, published Apr. 21, 1995 disclose two further typical counting devices which are partially shown in FIG. 2 and which include a housing 10 having a number of spring legs 11 extended therefrom. The spring legs 11 each has one end 72 solidly secured to or formed integral with the housing 10 such that the spring legs 11 may include a suitable resilience to bias against the projections 73, 74 of the dials 12. The spring legs 11 each has only one end secured to the housing 10 and may have a stress-concentration problem and may be easily damaged or broken from the housing after use.

As shown in FIG. 3, illustrated is another typical counting device including a number of dials 12 each having a bottom hole 120 formed therein for rotatably receiving and securing the hubs 13 of a housing 77 and each having a number of depressions 121 formed in the inner peripheral portion thereof. The hubs 13 each includes a channel 131 formed therein. The dials 12 each includes a spring 14 engaged in the hole 120 thereof and received in the channel 131 of the hub 13, and two balls 15 engaged in the ends of the spring 14 for being biased to engage with the depressions 121 of the dials 12. The typical counting device includes a complicated configuration that may not be easily manufactured and assembled.

The present invention has arisen to mitigate and/or obviate the afore-described disadvantages of the conventional counting devices.

### SUMMARY OF THE INVENTION

The primary objective of the present invention is to provide a counting device for effectively counting the strikes or the score of the golf games or the table tennis games or the tennis games or the like.

In accordance with one aspect of the invention, there is provided a counting device comprising a housing, at least one spring-biasing member disposed in the housing and including a side portion having an opening formed therein for defining a spring arm, the spring arm including two ends coupled to the spring-biasing member, and at least one dial rotatably received in the housing and including an outer peripheral portion engaged with the spring arm of the spring-biasing member and for positioning the dial to the housing.

The housing includes a bottom plate, the spring-biasing member includes a block secured on the bottom plate, and having a side portion spaced from the bottom plate for a gap, and having the spring arm formed in the side portion thereof.

The dial includes an outer peripheral portion having a plurality of projections extended therefrom, the spring arm includes a depression formed therein for receiving the projections of the dial.

The spring arm includes two inclined surfaces formed therein for defining the depression between the inclined surfaces, and includes two curved surfaces formed between the inclined surfaces and the spring arm.

The housing includes a side portion having at least one notch formed therein, the dial includes a peripheral portion having a plurality of numerals provided therein and to be shown through the notch of the housing.

One or more second dials are further provided and each includes a bottom portion having a chamber formed therein, at least one hub provided in the housing and having a channel formed therein, a second spring-biasing member received in the chamber of the second dial and engaged in the channel of the hub, the second spring-biasing member including at least one catch extended therefrom for engaging with the second dial and for positioning the second dial to the housing.

The second spring-biasing member includes an opening formed therein for defining the catch. The second dial includes a plurality of recesses formed therein and communicating with the chamber thereof for receiving the catch.

The housing includes a window formed therein, the second dial includes a peripheral portion having a plurality of numerals provided therein and to be shown through the window of the housing.

Further objectives and advantages of the present invention will become apparent from a careful reading of a detailed description provided hereinbelow, with appropriate reference to accompanying drawings.

### BRIEF DESCRIPTION OF THE DRAWINGS

FIG. 1 is a top plane schematic view of a typical counting device;

FIG. 2 is a partial plane schematic view illustrating the other typical counting device;

FIG. 3 is a partial exploded view illustrating a further typical counting device;

FIG. 4 is a top plane schematic view illustrating a counting device in accordance with the present invention;

FIG. 5 is a bottom plane schematic view illustrating the bottom of the upper plate of a housing of the counting device in accordance with the present invention;

FIG. 6 is a top plane schematic view of counting device, in which the upper plate of the housing is removed for showing the inner structure of the housing;

FIG. 7 is a partial exploded view of the counting device;

FIG. 8 is a top plane schematic view illustrating the operation of the counting device;

FIG. 9 is a partial exploded view showing the other dials of the counting device;

FIG. 10 is a top plane schematic view illustrating the other embodiment or the other application of the counting device;

FIG. 11 is a partial exploded view showing the counting device as shown in FIG. 10;

FIG. 12 is a top plane schematic view illustrating a further embodiment or application of the counting device;

FIG. 13 is a top plane schematic view illustrating a still further embodiment or application of the counting device;

FIG. 14 is a cross sectional view taken along lines 14-14 of FIG. 13;

FIG. 15 is an exploded and cross sectional view of the counting device as shown in FIGS. 13, 14;

FIG. 16 is a top plane schematic view illustrating another embodiment or application of the counting device;

FIG. 17 is a cross sectional view taken along lines 17-17 of FIG. 16; and

FIG. 18 is an exploded and cross sectional view of the counting device as shown in FIGS. 16, 17.

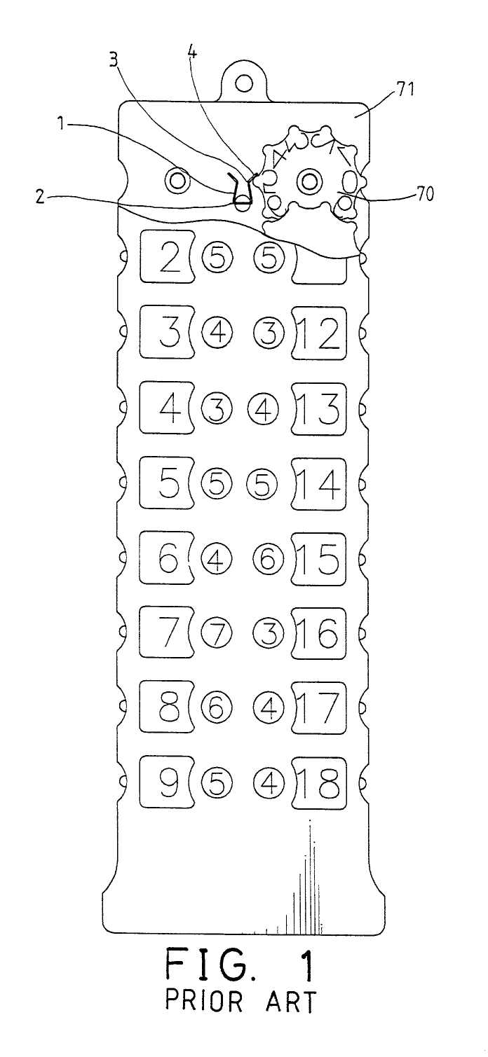

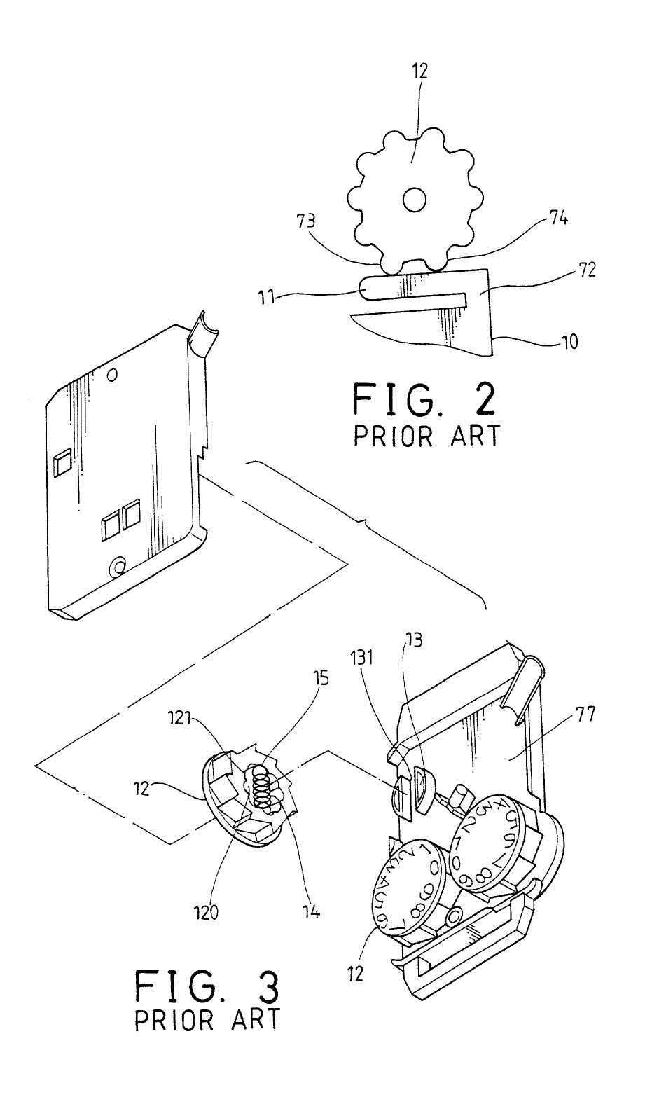

### DETAILED DESCRIPTION OF THE PREFERRED EMBODIMENT

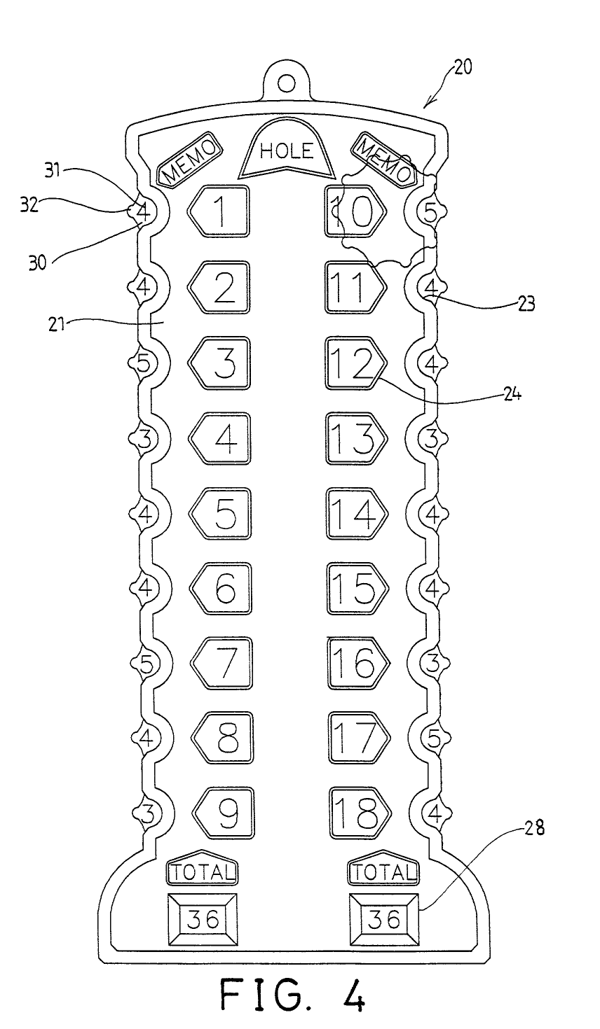

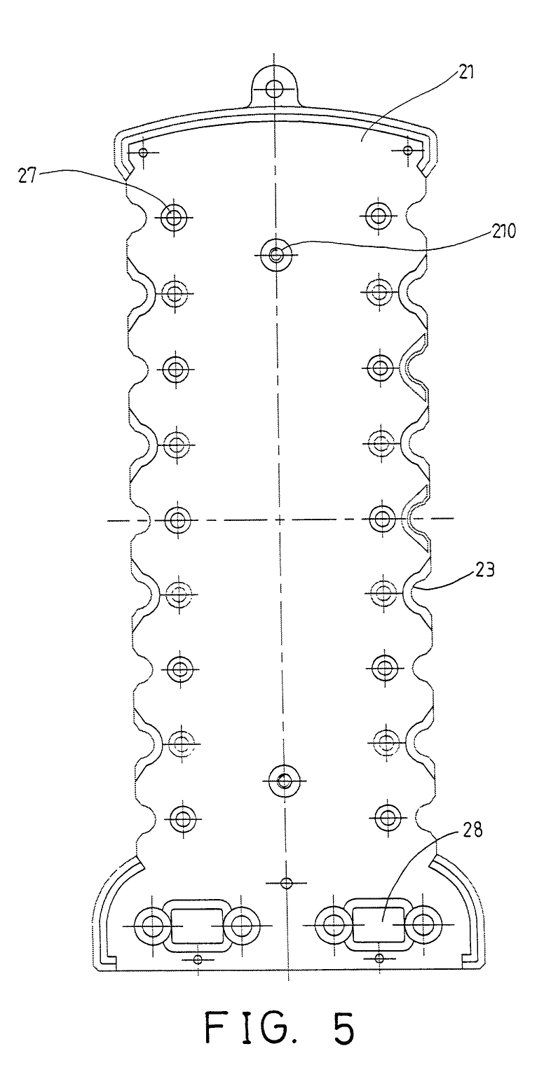

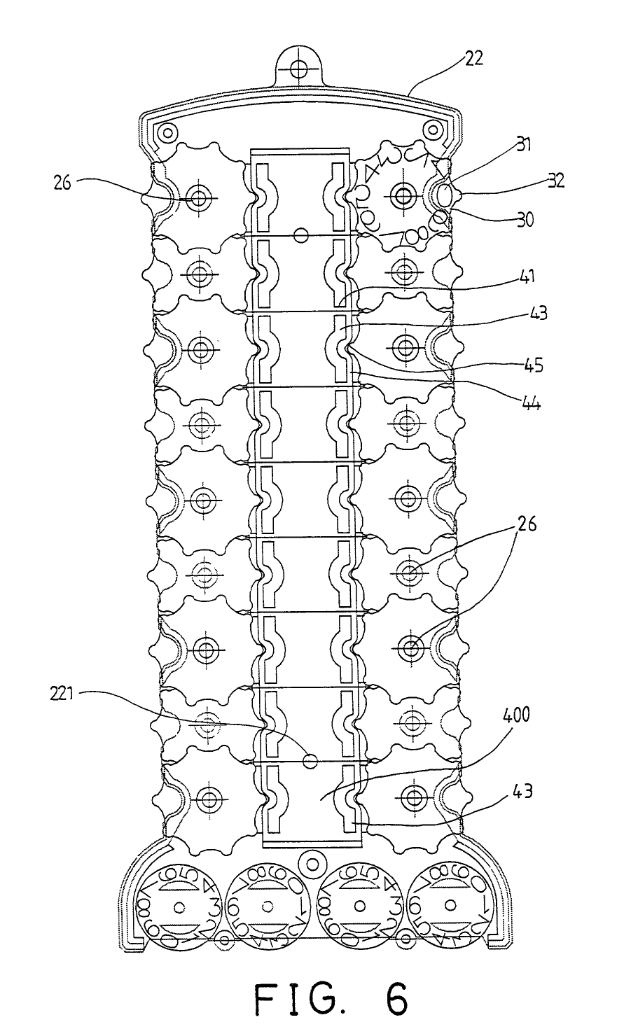

Referring to the drawings, and initially to FIGS. 4-8, a counting device in accordance with the present invention comprises a housing 20 including an upper plate 21 and a bottom plate 22 secured together by fasteners, for example. FIG. 4 shows the upper portion of the housing 20 of the counting device, and FIG. 5 shows the bottom view of the upper plate 21. In FIG. 6, the upper plate 21 has been removed from the housing 20 for showing the inner structure of the counting device. The upper plate 21 includes two side portions each having one or more notches 23 formed therein, particularly nine (9) notches 23 formed therein for showing the scores of the nine (9) or the eighteen (18) holes of the golf games or the like. The upper plate 21 includes a lower portion having one or more windows 28 formed therein for showing the total numbers of the strikes or shots or the like of the golf games.

A number of dials 30 are rotatably secured between the upper plate 21 and the bottom plate 22 with pivot pins 26 respectively, and each includes a number of numerals 31 provided thereon, particularly the numerals from 0 to 9 provided on the upper surface thereof, and each includes a number of projections 32 extended radially outward therefrom for allowing the dials 30 to be easily rotated relative to the housing 20 about the pivot pins 26. The numerals 31 of the dials 30 may be shown through the notches 23 of the upper plate 21 (FIG. 4). The bottom portion of the upper plate 21 includes a number of orifices 27 (FIG. 5) formed therein for rotatably receiving the pivot pins 26 respectively. The upper plate 21 may include a number of indicating numbers 24 provided thereon (FIG. 4) for showing the number of the holes of the golf games, for example.

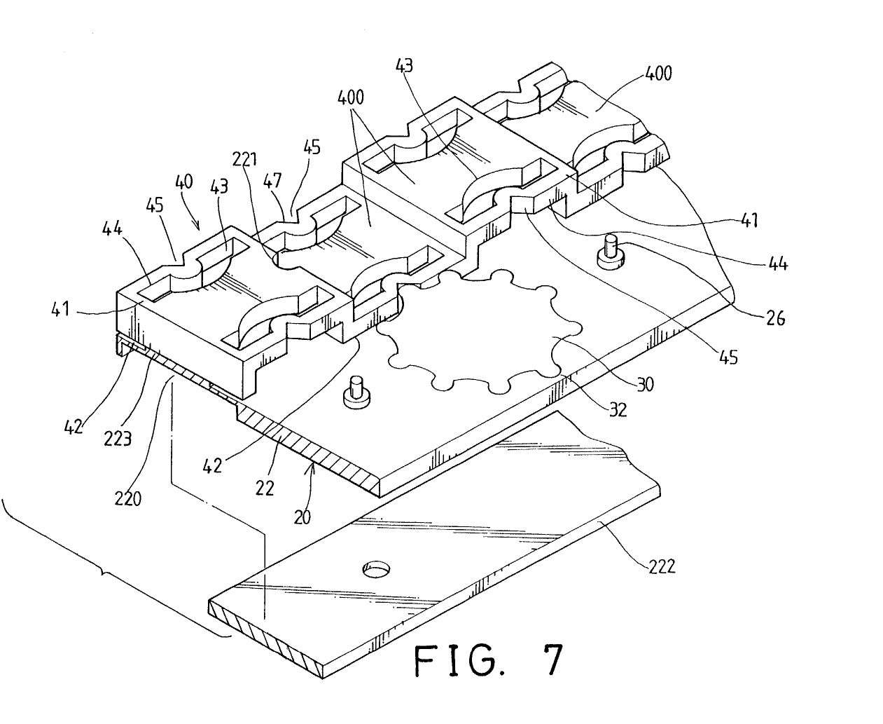

As shown in FIGS. 6-8, the housing 20 includes a number of spring-biasing members 40 provided therein for engaging with and for positioning the dials 30. The housing 20 includes a recess 220 (FIG. 7) formed in the bottom of the bottom plate 22, and includes one or more apertures 221 formed therein, and preferably formed through the spring-biasing members 40 (FIG. 6) for receiving fasteners or the like which may be threaded to the screw holes 210 (FIG. 5) of the upper plate 21 for securing the upper plate 21 and the bottom plate 22 together. A decorative board 222 may be engaged in the recess 220 of the bottom plate 22 and secured to the bottom plate 22 with the fasteners. The bottom plate 22 includes a bulge 223 (FIG. 7) extended upward therefrom for supporting the spring-biasing members 40 and for partially spacing the spring-biasing members 40 from the bottom plate 22 and for forming a gap 42 between the sides of the spring-biasing members 40 and the bottom plate 22.

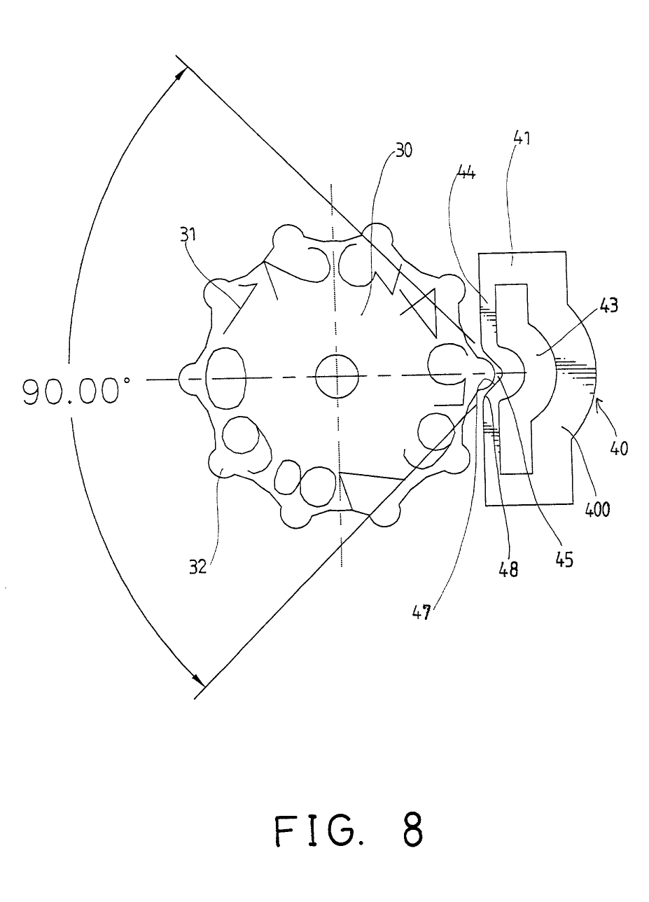

The spring-biasing members 40 each includes a block 400 having an opening, particularly an enclosed opening 43 formed in either or both of the sides of the block 400, for forming a spring arm 44 on the outer portion of each of the sides of the block 440. The spring arms 44 each includes two ends secured to the block 400 with an integral coupling member 41, and each includes a V-shaped depression 45 formed on the outer portion thereof, particularly formed in the middle of the outer portion of the spring arms 44 respectively for receiving the projections 32 of the dials 30. As best shown in FIG. 8, the V-shaped depressions 45 of the spring arms 44 each preferably includes a 90-degree included angle defined between two inclined sides or inclined surfaces 47. Two curved surfaces 48 are formed between the inclined sides 47 and the spring arm 44 for allowing the projections 32 of the dials 30 to be easily engaged into and disengaged from the depressions 45 of the spring arms 44.

It is to be noted that the spring arms 44 each includes two ends solidly secured to the block 400 with the coupling members 41, and are spaced from the block 400 with the opening 43 and spaced from the bottom plate 22 with the gap 42 (FIG. 7), such that the spring arms 14 include a suitable resilience and include an integral configuration having a suitable strength for preventing the spring arms 14 from being broken. The distance between two adjacent pivot pins 26 is smaller than the diameter of the dials 30, such that the dials 30 have a peripheral portion superposed with each other.

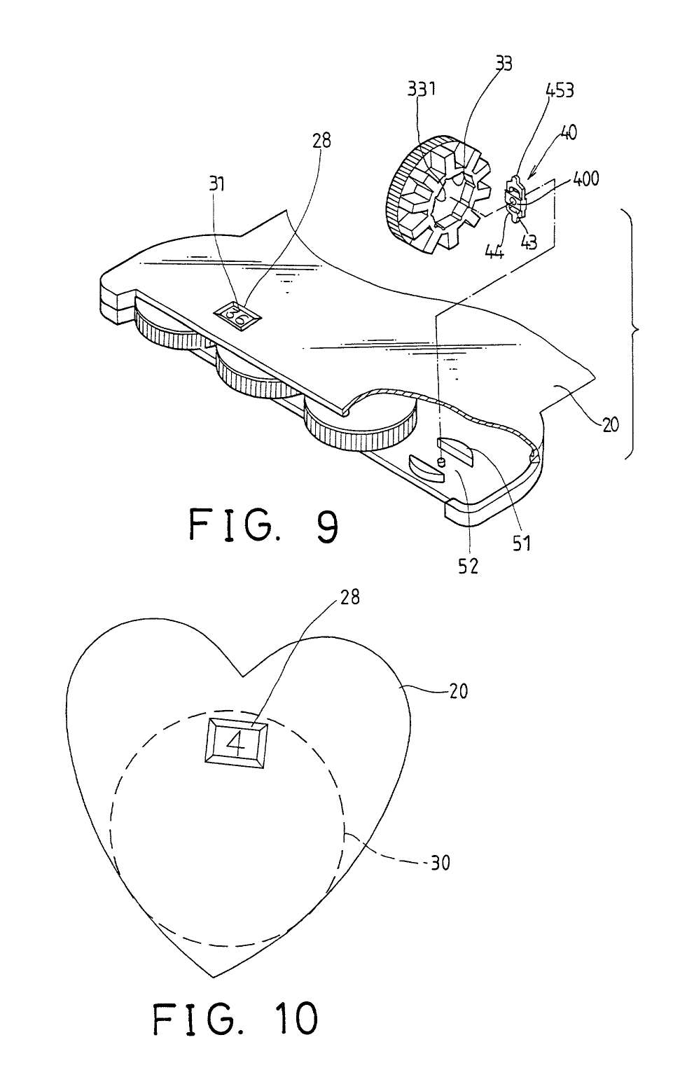

Referring next to FIG. 9, the housing 20 includes one or more hubs 51 provided in the lower portion thereof and each having a channel 52 formed therein. The dials 30 each includes a chamber 33 formed therein for receiving a spring-biasing member 40 therein. The spring-biasing member 40 also includes a block 400 secured in the channel 52 of the hub 51 and having an opening 43 formed therein for forming or defining two spring arms 44 on the ends, and having two catches 453 extended outward therefrom for engaging with the recesses 331 of the dials 30 and for positioning the dials 30 to the housing 20. The numerals 31 of two adjacent dials 30 may be shown through the windows 28 of the housing 20 and may be used to indicate the total numbers of the strikes or the like of the nine holes or the eighteen holes of the golf games.

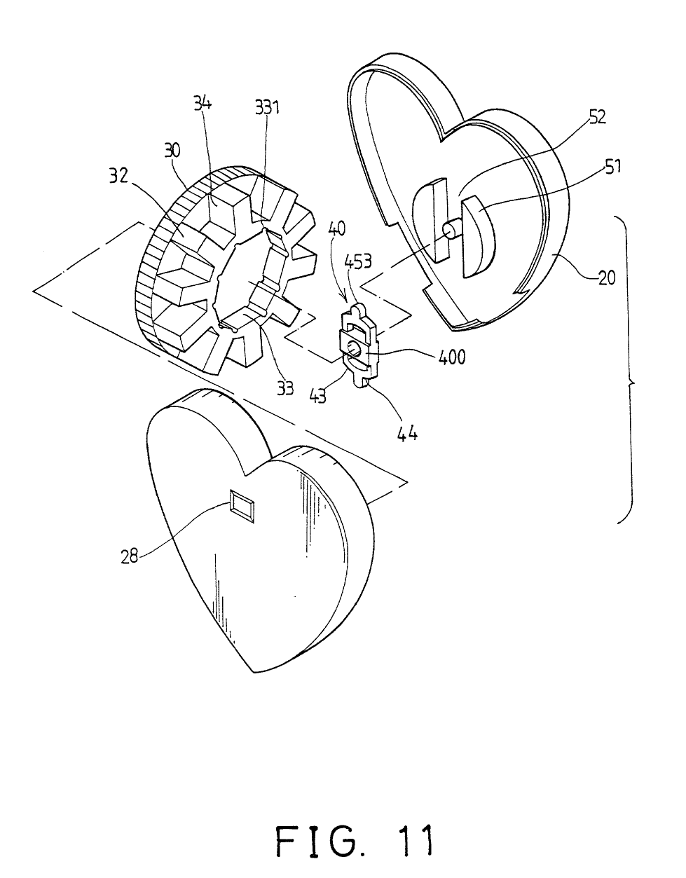

Referring next to FIGS. 10 and 11, a single dial 30 may be rotatably received in a smaller housing 20 and may include the spring-biasing member 40 disposed in the chamber 33 thereof and disposed in the channel 52 of the hub 51 and having a number of catches 453 for engaging with the recesses 331 of the dials 30 and for positioning the dials 30 to the housing 20. The counting device includes a small size may be used for counting the strikes of one of the holes of the golf games, for example.

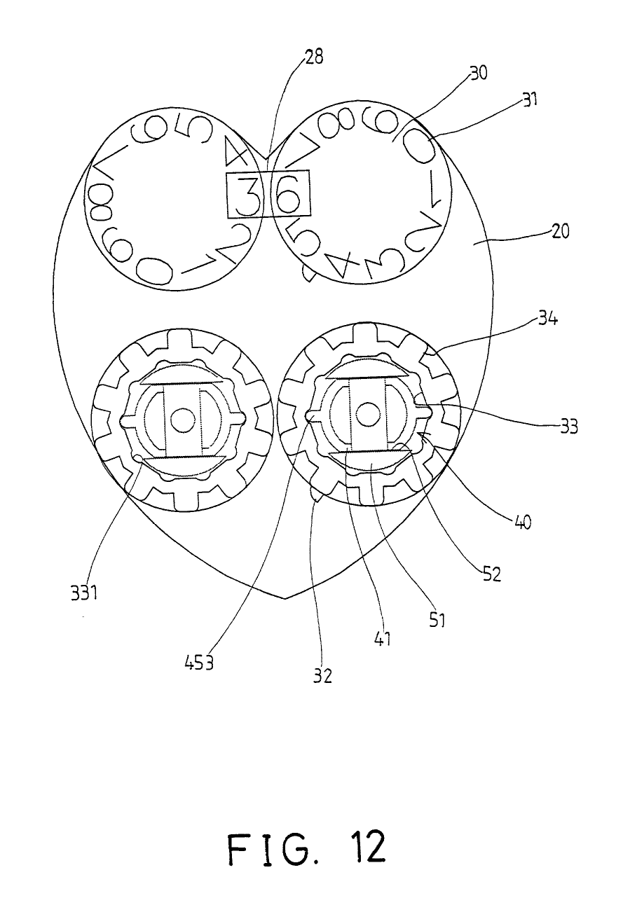

Referring next to FIG. 12, two pairs of dials 30 may be rotatably received in the other housing 20 and may each include a spring-biasing member 40 disposed in the chamber 33 thereof and disposed in the channel 52 of the hub 51 for engaging with the recesses 331 of the dials 30 and for positioning the dials 30 to the housing 20. The two pairs of the dials 30 of the counting device may each be used for counting the strikes of nine of the holes of the golf games, for example.

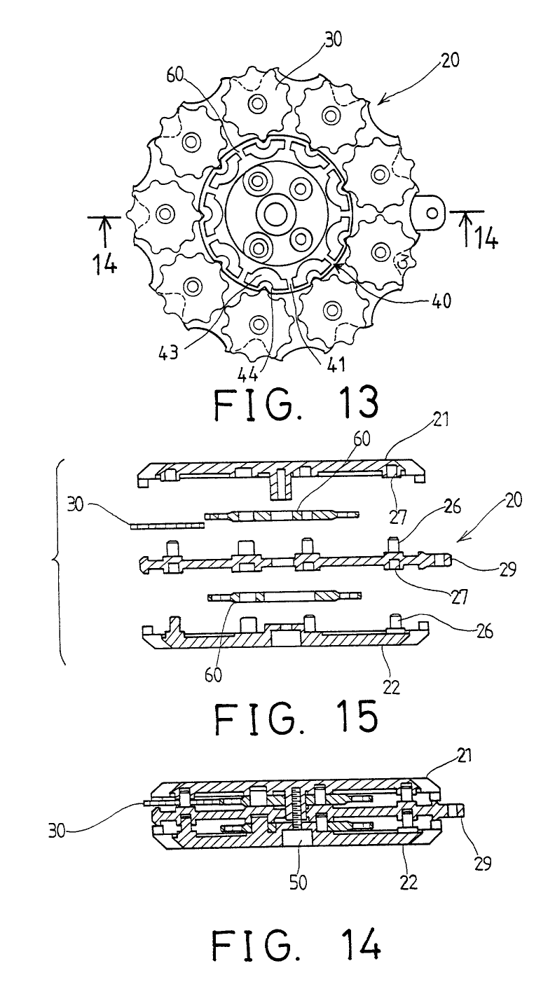

Referring next to FIGS. 13-15, the counting device may include nine dials 30 rotatably secured in the peripheral portion of the housing 20 for indicating the strikes of the nine holes of the golf games, and may include one or more seats 60 disposed in the middle portion of the housing 20 and each having nine spring-biasing members 40 provided on the outer peripheral portion thereof for engaging with the dials 30 respectively. The seats 60 and the dials 30 may be disposed between the upper plate 21 and the bottom plate 22 and a partition 29. The upper plate 21 and the partition 29 may include one or more orifices 27 formed therein for receiving the pivot pins 26.

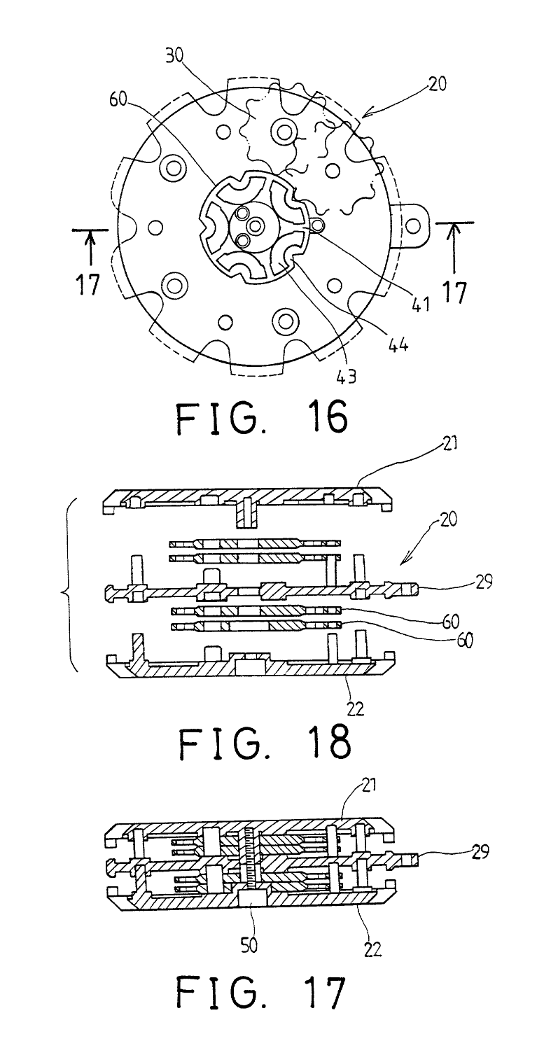

Referring next to FIGS. 16-18, the counting device may include two or more seats 60 disposed between the upper plate 21 and the partition 29, or between the bottom plate 22 and the partition 29 respectively.

Accordingly, the counting device in accordance with the present invention may be used for effectively counting the strikes or the score of the golf games or the table tennis games or the like.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A counting device comprising:
a housing,
at least one spring-biasing member disposed in said housing and including a side portion having an opening formed therein for defining a spring arm, said spring arm including two ends coupled to said at least one spring-biasing member, and
at least one dial rotatably received in said housing and including an outer peripheral portion engaged with said spring arm of said at least one spring-biasing member and for positioning said at least one dial to said housing.

2. The counting device according to claim 1, wherein said housing includes a bottom plate, said at least one spring-biasing member includes a block secured on said bottom plate, and having a side portion spaced from said bottom plate for a gap, and having said spring arm formed in said side portion thereof.

3. The counting device according to claim 1, wherein said at least one dial includes an outer peripheral portion having a plurality of projections extended therefrom, said spring arm includes a depression formed therein for receiving said projections of said at least one dial.

4. The counting device according to claim 3, wherein said spring arm includes two inclined surfaces formed therein for defining said depression between said inclined surfaces, and includes two curved surfaces formed between said inclined surfaces and said spring arm.

5. The counting device according to claim 1, wherein said housing includes a side portion having at least one notch formed therein, said at least one dial includes a peripheral portion having a plurality of numerals provided therein and to be shown through said at least one notch of said housing.

6. The counting device according to claim 1 further comprising at least one second dial including a bottom portion having a chamber formed therein, at least one hub provided in said housing and having a channel formed therein, a second spring-biasing member received in said chamber of said at least one second dial and engaged in said channel of said at least one hub, said second spring-biasing member including at least one catch extended therefrom for engaging with said at least one second dial and for positioning said at least one second dial to said housing.

7. The counting device according to claim 6, wherein said second spring-biasing member includes an opening formed therein for defining said at least one catch.

8. The counting device according to claim 6, wherein said at least one second dial includes a plurality of recesses formed therein and communicating with said chamber thereof for receiving said at least one catch.

9. The counting device according to claim 6, wherein said housing includes a window formed therein, said at least one second dial includes a peripheral portion having a plurality of numerals provided therein and to be shown through said window of said housing.

10. A counting device comprising:
a housing including at least one hub provided therein and having a channel formed therein,
at least one dial rotatably received in said housing and including a bottom portion having a chamber formed therein,
at least one spring-biasing member received in said chamber of said at least one dial and engaged in said channel of said at least one hub, said second spring-biasing member including at least one catch extended therefrom for engaging with said at least one dial and for positioning said at least one dial to said housing.
